(19) United States
(12) Patent Application Publication
(10) Pub. No.: US 2026/0370073 A1
(43) Pub. Date: Nov. 19, 2026

(54) ROTATING ELECTRIC MACHINE

(71) Applicant: HONDA MOTOR CO., LTD., Tokyo (JP)

(72) Inventors: Fumiya Nishii, Wako-shi (JP); Shingo Soma, Wako-shi (JP)

(21) Appl. No.: 19/543,891

(22) Filed: Feb. 19, 2026

(30) Foreign Application Priority Data
Mar. 28, 2025 (JP) 2025-055704

(51) Int. Cl. H02K 1/276; H02K 1/16

(52) U.S. Cl. CPC H02K 1/2766; H02K 1/165; H02K 2201/03; H02K 2213/03

(57) ABSTRACT

A rotating electric machine includes a stator formed by slots and teeth that form the slots, a permanent magnet having an arc shape recessed relative to the stator and having a magnetization direction formed in a circumferential direction along the arc shape, a rotor having a magnet insertion hole into which the permanent magnet is inserted and a recess formed along the permanent magnet, a gap provided on a side opposite to the stator with respect to the magnet insertion hole, an inner peripheral side rib formed on a side of the stator in the magnet insertion hole, and an outer peripheral side rib that partitions the gap from the magnet insertion hole. A width of the outer peripheral side rib is smaller than a width of the inner peripheral side rib.

### CROSS-REFERENCE TO RELATED APPLICATION

Priority is claimed on Japanese Patent Application No. 2025-055704, filed Mar. 28, 2025, the content of which is incorporated herein by reference.

### BACKGROUND OF THE INVENTION

### Field of the Invention

The present invention relates to a rotating electric machine.

### Description of Related Art

In recent years, efforts toward the realization of a low-carbon or decarbonized society have become active, and research and development on rotating electric machines is being conducted in order to reduce CO₂ emissions and improve energy efficiency in vehicles.

For example, as a rotating electric machine, a reluctance motor that has a d-axis magnetic flux path that generates magnet torque among components of rotational torque generated by a rotating magnetic field from a stator and a q-axis magnetic flux path that generates reluctance torque among the components has been disclosed (see, for example, International Publication No. 2018/101183).

### SUMMARY OF THE INVENTION

Incidentally, in a technology relating to the reluctance motor, a large reverse magnetic field is applied to a magnet. For this reason, a magnet with high coercive force is required, and from this perspective, there is still room for improvement.

Aspects of the present invention can reduce the coercive force of a permanent magnet. Aspects of the present invention contribute to improve energy efficiency.

Aspects of the present invention propose the following configurations. (1) A rotating electric machine according to the present invention includes a stator (for example, a stator 2 of an embodiment) formed by slots (for example, slots 14 of the embodiment) into which a winding wire (for example, a coil 12 of the embodiment) is inserted and teeth (for example, teeth 13 of the embodiment) that form the slots, a magnet (for example, a permanent magnet 22 of the embodiment) having an arc shape recessed relative to the stator and having a magnetization direction formed in a circumferential direction along the arc shape, a rotor (for example, a rotor 3 of the embodiment) having a magnet insertion hole (for example, a magnet insertion hole 31 of the embodiment) into which the magnet is inserted and a recess formed on an outer peripheral edge (for example, an outer peripheral edge 21a of the embodiment) along the magnet, a gap (for example, a gap 32 of the embodiment) provided on a side opposite to the stator with respect to the magnet insertion hole, an inner peripheral side rib (for example, an inner peripheral side rib 34 of the embodiment) formed on a side of the stator in the magnet insertion hole, and an outer peripheral side rib (for example, an outer peripheral side rib 35 of the embodiment) that partitions the gap from the magnet insertion hole and is in contact with the magnet, wherein a width (for example, a width W2 of the embodiment) of the outer peripheral side rib is selected to be smaller than a width (for example, a width W1 of the embodiment) of the inner peripheral side rib.

With this configuration, the inner peripheral side rib is formed on a side of the stator in the magnet insertion hole. Therefore, the inner peripheral side rib is formed on the inner peripheral side of the magnet. In addition, the outer peripheral side rib is formed so as to partition the gap from the magnet insertion hole and to be in contact with the magnet. Therefore, the outer peripheral side rib is formed on the outer peripheral side of the magnet.

Here, the larger the proportion of the steel plate width on the inner peripheral side of the magnet, the more likely it is that the magnetic flux of the magnet can be changed with respect to the q-axis applied current. Therefore, the width of the outer peripheral side rib is made smaller than the width of the inner peripheral side rib. Therefore, it is possible to change the magnetic flux of the magnet in the magnet with respect to the q-axis applied current. As a result, in the case of the low load, the q-axis applied current is kept small, and the magnetic flux of the magnet is kept small, and thus it is possible to improve efficiency. In addition, in the case of the high load, it is possible to ensure a high output (torque) at high speed rotation by increasing the q-axis applied current to increase the magnetic flux of the magnet.

In addition, it is possible to change the magnetic flux of the magnet in the magnet with respect to the q-axis applied current, and thus it is possible to reduce the demagnetization rate of the magnet. As a result, it is possible to reduce the coercive force of the magnet.

(2) In the above aspect, the width of the outer peripheral side rib may be greater than 0 and equal to or less than 0.09 with respect to an outer diameter (for example, an outer diameter Rob of the embodiment) of an outer periphery (for example, an outer periphery 22a of the embodiment) of the magnet on a side opposite to the stator.

With this configuration, the ratio of the width of the outer peripheral side rib to the outer diameter of the outer periphery of the magnet is set to be greater than 0 and equal to or less than 0.09. As a result, it is possible to improve the output of the rotating electric machine and to reduce the demagnetization rate of the magnet.

(3) In the above aspect, the outer peripheral side rib may be formed of a non-magnetic steel plate.

With this configuration, the outer peripheral side rib is formed of a non-magnetic steel plate. As a result, it is possible to prevent the d-axis inductance from becoming excessive, to reduce the magnetic flux density from the outer peripheral side rib, and to improve the demagnetization resistance performance.

(4) The above aspect may further include a flux barrier (for example, a flux barrier 33 of the embodiment) provided at an end portion of the magnet insertion hole on a side of an inner periphery (for example, an inner periphery 31b of the embodiment), wherein an end portion (for example, an end portion 22c of the embodiment) of the magnet is in contact with an end portion (for example, an end portion 31c of the embodiment) of the magnet insertion hole.

With this configuration, the flux barrier is provided at the end portion of the magnet insertion hole on a side of the inner periphery. In addition, the end portion of the magnet is in contact with the end portion of the magnet insertion hole. As a result, it is possible to increase the demagnetization resistance performance in the magnet.

(5) In the above aspect, a ratio (L2/L1) of a length (L1) along the magnet to a length (L2) of the flux barrier in contact with the magnet, and a ratio (W1/W3) of a width (W1) of the inner peripheral side rib to a width (W3) of the flux barrier may be set to (L2/L1)≥(W1/W3).

With this configuration, the ratio (L2/L1) of the length (L1) along the arc-shaped magnet to the length (L2) of the flux barrier, and the ratio (W1/W3) of the width (W1) of the inner peripheral side rib to the width (W3) of the flux barrier are set to (L2/L1)≥(W1/W3).

Therefore, it is possible to suppress a vector change in a direction in which the magnetic flux of the magnet is short-circuited due to the reverse magnetic field. As a result, it is possible to improve the demagnetization resistance performance in the magnet.

According to the present invention, it is possible to reduce the coercive force of a permanent magnet.

### BRIEF DESCRIPTION OF THE DRAWINGS

FIG. 1 is a cross-sectional view showing a rotating electric machine according to an embodiment of the present invention.

FIG. 2 is a cross-sectional view showing a main part of a stator and a rotor in the rotating electric machine according to the embodiment.

FIG. 3 is a cross-sectional view including an enlarged portion of one pole of the rotor in the rotating electric machine according to the embodiment.

FIG. 4 is a cross-sectional view showing a length ratio of a flux barrier in the rotating electric machine according to the embodiment.

FIG. 5 is a cross-sectional view showing a width ratio of the flux barrier in the rotating electric machine according to the embodiment.

FIG. 6 is a cross-sectional view showing an outer peripheral side rib and an inner peripheral side rib in the rotating electric machine according to the embodiment.

FIG. 7 is a cross-sectional view illustrating a magnetic flux flow during the low load in the rotating electric machine according to the embodiment.

FIG. 8 is a cross-sectional view illustrating a magnetic flux flow during the high load in the rotating electric machine according to the embodiment.

FIG. 9 is a cross-sectional view showing an outer peripheral side rib and an inner peripheral side rib in a rotating electric machine of Comparative Example 1.

FIG. 10 is a cross-sectional view illustrating a magnetic flux flow during the low load in the rotating electric machine of Comparative Example 1.

FIG. 11 is a cross-sectional view illustrating a magnetic flux flow during the high load in the rotating electric machine of Comparative Example 1.

FIG. 12 is a cross-sectional view showing an outer peripheral side rib and an inner peripheral side rib in a rotating electric machine of Comparative Example 2.

FIG. 13 is a cross-sectional view illustrating a magnetic flux flow during the low load in the rotating electric machine of Comparative Example 2.

FIG. 14 is a cross-sectional view illustrating a magnetic flux flow during the high load in the rotating electric machine of Comparative Example 2.

FIG. 15 is a graph showing changes in magnetic flux of a magnet with respect to a q-axis applied current in the rotating electric machine of the embodiment, the rotating electric machine of Comparative Example 1, and the rotating electric machine of Comparative Example 2.

FIG. 16 is a graph showing an efficiency map of the rotating electric machine according to the embodiment.

FIG. 17 is a cross-sectional view showing the amount of magnetic flux from an outer periphery of a permanent magnet in the rotating electric machine according to the embodiment.

FIG. 18 is a graph illustrating relationships of an output and a demagnetization rate with respect to a width of the outer peripheral side rib in the rotating electric machine.

FIG. 19 is a cross-sectional view showing a rotor core and a permanent magnet in the rotating electric machine according to the embodiment.

FIG. 20 is a cross-sectional view showing a flow of magnetic flux in the rotating electric machine of the embodiment.

FIG. 21 is a cross-sectional view showing a rotor core and a permanent magnet in a rotating electric machine of Comparative Example 3.

FIG. 22 is a cross-sectional view showing a flow of magnetic flux in the rotating electric machine of Comparative Example 3.

FIG. 23 is a cross-sectional view showing a rotor core and a permanent magnet in a rotating electric machine of Comparative Example 4.

FIG. 24 is a cross-sectional view showing a flow of magnetic flux in the rotating electric machine of Comparative Example 4.

FIG. 25 is a cross-sectional view showing a rotor core and a permanent magnet in a rotating electric machine of Comparative Example 5.

FIG. 26 is a cross-sectional view showing a flow of magnetic flux in the rotating electric machine of Comparative Example 5.

FIG. 27 is a graph illustrating the demagnetization rates of the embodiment and Comparative Example 3 to Comparative Example 5.

FIG. 28 is a cross-sectional view showing a magnetic flux flow in a first example of the flux barrier.

FIG. 29 is a cross-sectional view showing a magnetic flux flow in a second example of the flux barrier.

FIG. 30 is a cross-sectional view showing a magnetic flux flow in a third example of the flux barrier.

FIG. 31 is a cross-sectional view showing a magnetic flux flow in a fourth example of the flux barrier.

FIG. 32 is a graph showing a relationship between the length ratio and the width ratio in the flux barrier according to the embodiment.

### DETAILED DESCRIPTION OF THE INVENTION

Hereinafter, a rotating electric machine according to an embodiment of the present invention will be described with reference to the drawings.

### Rotating Electric Machine

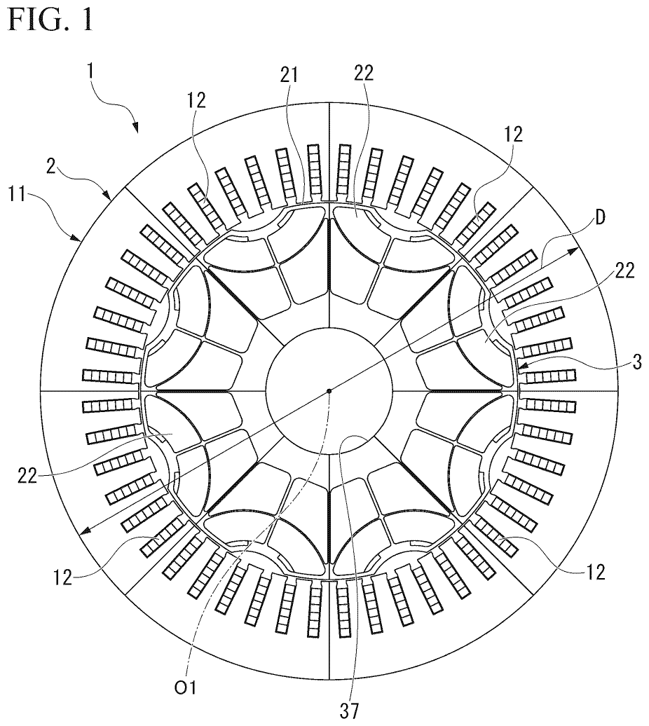

FIG. 1 is a cross-sectional view showing the rotating electric machine according to the embodiment.

As shown in FIG. 1, a rotating electric machine 1 is a driving motor mounted on a vehicle such as a hybrid vehicle or an electric vehicle. However, a configuration of the present invention is not limited to the driving motor, but can also be applied to a power generation motor, a motor for other purposes, and a rotating electric machine 1 (including a generator) for purposes other than vehicles.

The rotating electric machine 1 includes, for example, a stator 2 and a rotor 3. The rotating electric machine 1 is, for example, a normal saliency motor. In the following description, a direction along an axis O1, which is a central axis of the stator 2 and the rotor 3, may be simply referred to as an axial direction, a direction orthogonal to the axis O1 may be simply referred to as a radial direction, and a direction around the axis O1 may be simply referred to as a circumferential direction.

In the rotating electric machine 1, an outer diameter D of the stator 2 is selected from the range of Φ150 mm or more and Φ400 mm or less, for example. In addition, for the rotating electric machine 1, for example, when the outer diameter is Φ150 mm to Φ400 mm, the realistic number of pole pairs p is selected from the range of 3 pole pairs or more and 12 pole pairs or less.

### Stator

The stator 2 is formed in an annular shape centered on the axis O1. An outer peripheral portion of the stator 2 is fixed to an inner wall surface of a case (not shown). A portion of the stator 2 and the rotor 3 is disposed, for example, inside the case in a state of being immersed in a coolant.

The stator 2 includes a stator core 11 and a coil (winding wire) 12.

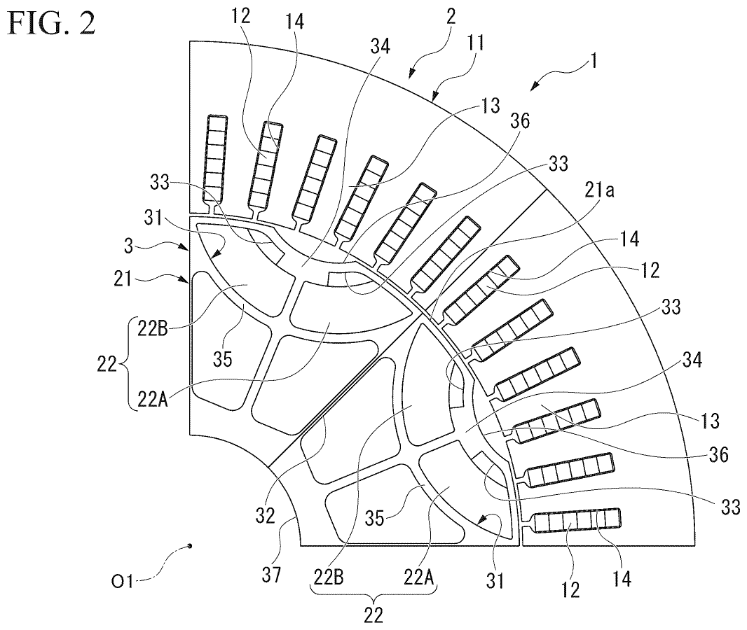

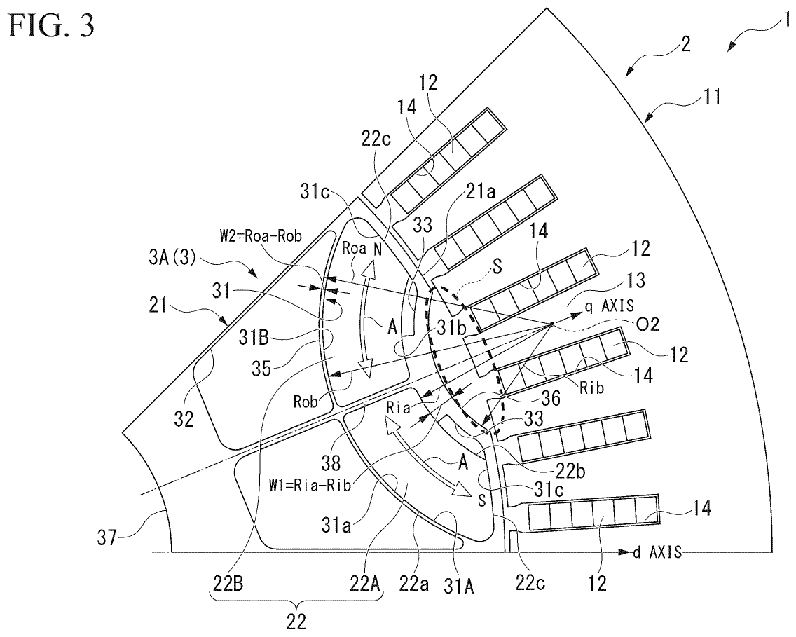

FIG. 2 is a cross-sectional view showing a main part of the stator and the rotor in the rotating electric machine. FIG. 3 is a cross-sectional view including an enlarged portion of one pole of the rotor in the rotating electric machine.

As shown in FIGS. 2 and 3, the stator core 11 is a stacked core formed by stacking a plurality of steel plates in the axial direction. The stator core 11 is formed in an annular shape centered on the axis O1. The stator core 11 has a plurality of teeth 13 and slots 14. The plurality of teeth 13 protrude radially inward from an inner peripheral portion of the stator core 11. The plurality of teeth 13 are provided in the circumferential direction. In the plurality of teeth 13, each slot 14 is formed between the teeth 13. The coil 12 is inserted into the slots 14 in the stator core 11.

### Rotor

The rotor 3 is formed, for example, in an annular shape. The rotor 3 is disposed inside the stator 2 in the radial direction with a gap therebetween. The rotor 3 is provided to be rotatable around the axis O1. When a current is applied to the coil 12 attached to the stator 2, a magnetic field is generated between the stator 2 and the rotor 3, thereby causing the rotor 3 to rotate around the axis O1 relative to the stator 2. The rotor 3 includes a rotor core 21 and a permanent magnet (magnet) 22.

### Rotor Core

The rotor core 21 is formed in an annular shape centered on the axis O1. The rotor core 21 is a stacked core formed by stacking a plurality of steel plates in the axial direction.

The rotor core 21 has a magnet insertion hole 31, a gap 32, a flux barrier 33, an inner peripheral side rib 34, an outer peripheral side rib 35, a recess 36, and a shaft insertion hole 37.

The magnet insertion hole 31 is provided on the outer peripheral portion of the rotor core 21. The magnet insertion hole 31 includes a first insertion hole 31A and a second insertion hole 31B. The first insertion hole 31A and the second insertion hole 31B are disposed continuously in the circumferential direction. The first insertion hole 31A is formed in an arc shape when viewed in the axial direction. The first insertion hole 31A passes through the rotor core 21 in the axial direction. The second insertion hole 31B is formed in an arc shape when viewed in the axial direction. The second insertion hole 31B passes through the rotor core 21 in the axial direction. The first insertion hole 31A and the second insertion hole 31B are formed symmetrically with respect to, for example, a q axis that passes through the axis O1 and extends in the radial direction.

The magnet insertion hole 31 is formed in an arc shape recessed radially inward relative to an outer peripheral edge 21a of the rotor core 21 when viewed in the axial direction by the first insertion hole 31A and the second insertion hole 31B. The magnet insertion hole 31 is formed, for example, symmetrically with respect to the q axis.

A reinforcing rib 38 is provided between the first insertion hole 31A and the second insertion hole 31B. The reinforcing rib 38 is disposed along the q axis. By providing the reinforcing rib 38 between the first insertion hole 31A and the second insertion hole 31B, for example, the rigidity of the rotor core 21 can be appropriately ensured.

The magnet insertion hole 31 has an outer periphery 31a, an inner periphery 31b, and an end portion 31c. The outer periphery 31a is formed as an arc on a side opposite to the stator 2 (that is, a side opposite to the outer peripheral edge 21a). The inner periphery 31b is formed as an arc on a side of the stator 2 (that is, a side of the outer peripheral edge 21a). The end portion 31c is disposed at both ends of the magnet insertion hole 31 in the circumferential direction.

The gap 32 is provided on a side opposite to the stator 2 with respect to the outer periphery 31a of the magnet insertion hole 31 (that is, on an inner side in the radial direction). The gap 32 is in contact with the outer peripheral side rib 35 of the magnet insertion hole 31.

The flux barrier 33 is provided on the inner peripheral side rib 34, which will be described below. That is, the flux barrier 33 is provided on a side of the outer peripheral edge 21a of the rotor core 21 with respect to the magnet insertion hole 31. The flux barrier 33 is open continuously to the magnet insertion hole 31. In other words, the flux barrier 33 is provided at an end portion of the magnet insertion hole 31 on a side of the inner periphery 31b so as to be open to the end portion (specifically, both end portions) on the side of the inner periphery 31b.

The inner peripheral side rib 34 is provided on a side of the stator 2 in the magnet insertion hole 31 (that is, on a side of the outer peripheral edge 21a) in the rotor core 21. The inner peripheral side rib 34 is formed in an arc shape along the inner periphery 31b of the magnet insertion hole 31. The inner peripheral side rib 34 has a flux barrier 33 at its end portion (specifically, at both end portions). The center of the inner peripheral side rib 34 is formed so as to be in contact with the permanent magnet 22, which will be described below.

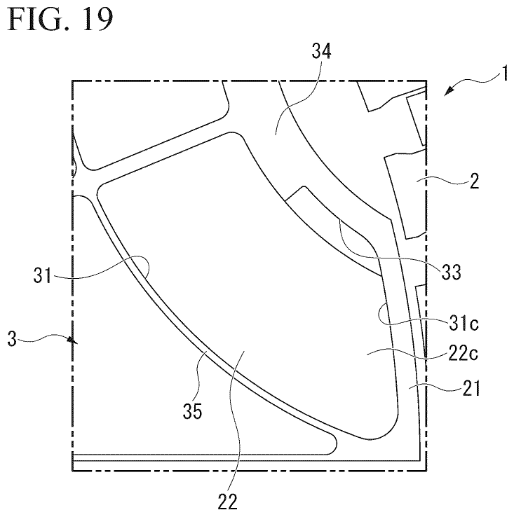

The inner peripheral side rib 34 has an outer periphery and an inner periphery. The outer periphery of the inner peripheral side rib 34 forms the inner periphery 31b of the magnet insertion hole 31. The inner periphery of the inner peripheral side rib 34 forms the recess 36. The reason for providing the flux barrier 33 at the end portion of the inner peripheral side rib 34 will be described below with reference to FIGS. 19 to 27.

The outer peripheral side rib 35 is formed so as to partition the gap 32 from the magnet insertion hole 31 and to be in contact with the permanent magnet 22, which will be described below. The outer peripheral side rib 35 is provided on the inner peripheral side of the rotor core 21 (that is, a side opposite to the stator 2). The outer peripheral side rib 35 is formed in an arc shape along the outer periphery 31a of the magnet insertion hole 31. The outer peripheral side rib 35 is formed of, for example, a non-magnetic steel plate.

The outer peripheral side rib 35 has an outer periphery and an inner periphery. The outer periphery of the outer peripheral side rib 35 forms the outer periphery of the gap 32. The inner periphery of the outer peripheral side rib 35 forms the outer periphery 31a of the magnet insertion hole 31.

The inner peripheral side rib 34 and the outer peripheral side rib 35 are formed in the shape of arcs concentrically about a center point O2. Specifically, the outer periphery of the inner peripheral side rib 34 is formed as an arc of a radius Ria centered on the center point O2. The inner periphery of the inner peripheral side rib 34 is formed as an arc of a radius Rib centered on the center point O2. A width W1 of the inner peripheral side rib 34 is as follows:

W1=Ria−Rib

However, the center point O2 is, for example, a center between the slots 14 in the circumferential direction and a center point of the tooth 13 in the radial direction. The center point of the tooth 13 in the radial direction is a center point between a base end (outermost end) 13a and the tip end (innermost end) 13b of the tooth 13 in the radial direction. The expression of “a center between the slots 14 in the circumferential direction” also includes a meaning of “approximately a center” having a certain degree of range in the circumferential direction. The center point O2 may be selected by other methods.

In addition, the outer periphery of the outer peripheral side rib 35 is formed as an arc of a radius Roa centered on the center point O2. The inner periphery of the outer peripheral side rib 35 is formed as an arc of a radius Rob centered on the center point O2. A width W2 of the outer peripheral side rib 35 is as follows:

W2=Roa−Rob

The width W2 of the outer peripheral side rib 35 is selected to be smaller than the width W1 of the inner peripheral side rib 34.

The expression of “a radius Rob centered on the center point O2” is the same as an expression of “an outer diameter of the outer periphery 31a of the magnet insertion hole 31,” or “an outer diameter of an outer periphery of the permanent magnet 22, which will be described below.” Hereinafter, the expression of “a radius Rob centered on the center point O2” may be referred to as an expression of “an outer diameter Rob of an outer periphery of the permanent magnet 22.”

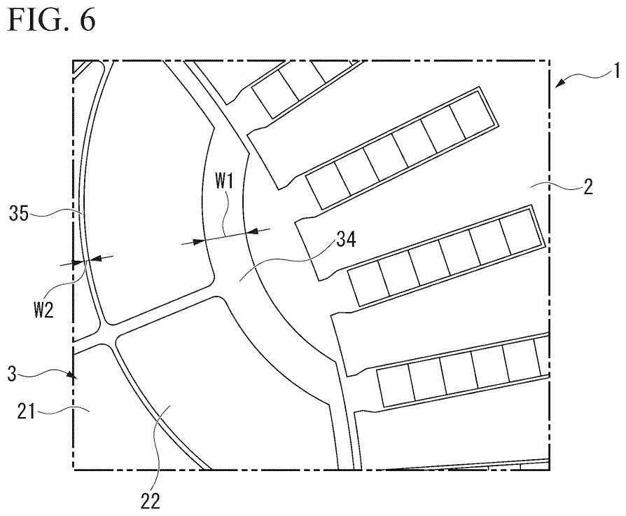

The reason why the width W2 of the outer peripheral side rib 35 is set to be smaller than the width W1 of the inner peripheral side rib 34 will be described below with reference to FIGS. 6 to 16.

The recess 36 is provided on the outer peripheral edge 21a of the rotor core 21. The recess 36 is formed in an arc shape recessed radially inward relative to the outer peripheral edge 21a of the rotor core 21 along the arc-shaped magnet insertion hole 31. The recess 36 is formed on the inner periphery of the inner peripheral side rib 34. That is, the recess 36 is formed as the arc of the radius Rib centered on the center point O2.

In addition, the recess 36 is formed along an inner periphery 22b of the permanent magnet 22, which will be described below. Therefore, a hollow wall (gap) S can be secured between the outer peripheral edge 21a of the rotor core 21 and the stator 2. The recess 36 is formed symmetrically with respect to the q axis.

The shaft insertion hole 37 is provided coaxially with the axis O1. The shaft insertion hole 37 passes through the rotor core 21 in the axial direction. A shaft (not shown) is inserted into the shaft insertion hole 37. The shaft is rotatably supported with respect to the case that houses the rotor 3 and the stator 2 via a bearing (not shown) attached to the case. As a result, the rotor core 21 and the shaft rotate integrally around the axis O1.

### Permanent Magnet

The permanent magnet 22 is inserted into each magnet insertion hole 31 of the rotor core 21. Specifically, the permanent magnet 22 includes a first magnet 22A and a second magnet 22B. The first magnet 22A is formed in an arc shape when viewed in the axial direction. The first magnet 22A is inserted into the first insertion hole 31A. The second magnet 22B is formed in an arc shape when viewed in the axial direction. The second magnet 22B is inserted into the second insertion hole 31B. The first magnet 22A and the second magnet 22B are disposed continuously in the circumferential direction. The first magnet 22A and the second magnet 22B are formed, for example, symmetrically with respect to the q axis.

In the embodiment, an example in which the permanent magnet 22 is formed of two magnets, the first magnet 22A and the second magnet 22B has been described, but the permanent magnet 22 may be formed of a single magnet.

A plurality of permanent magnets 22 are provided in the circumferential direction. The permanent magnet 22 is formed in an arc shape recessed radially inward relative to the outer peripheral edge 21a of the rotor core 21 (that is, the stator 2) along the shape of the magnet insertion hole 31. The permanent magnet 22 is formed symmetrically with respect to the q axis. That is, the q axis can be disposed at a center of the permanent magnet 22 in the circumferential direction. The permanent magnet 22 has an arc-shaped outer periphery 22a, an arc-shaped inner periphery 22b, and an end portion 22c.

The arc-shaped outer periphery 22a is a periphery formed in an arc shape along the outer periphery 31a of the magnet insertion hole 31 on a side opposite to the stator (that is, a side opposite to the outer peripheral edge 21a) in the permanent magnet 22. The arc-shaped outer periphery 22a is in contact with the inner periphery of the outer peripheral side rib 35.

The arc-shaped inner periphery 22b is a periphery formed in an arc shape along the inner periphery 31b of the magnet insertion hole 31 and the flux barrier 33 on a side of the stator (that is, a side of the outer peripheral edge 21a) in the permanent magnet 22. The arc-shaped inner periphery 22b is in contact with the outer periphery of the inner peripheral side rib 34 and the flux barrier 33.

The end portion 22c is disposed at both ends of the permanent magnet 22 in the circumferential direction. The end portion 22c is in contact with the end portion 31c of the magnet insertion hole 31.

As the permanent magnet 22, for example, a hot-worked magnet, a bulk magnet of iron nitride (Fe₁₆N₂), or the like may be used. The hot-worked magnet and the bulk magnet of Fe₁₆N₂ have the property of excellent freedom in shape and orientation. The permanent magnet 22 is formed such that a magnetization direction is oriented in a direction of arrow A along the arc shape of the permanent magnet 22 in the circumferential direction of the permanent magnet 22. That is, an orientation direction of the permanent magnet 22 is oriented in the circumferential direction in the permanent magnet 22. The permanent magnet 22 has, for example, an N pole at its left end portion and an S pole at its right end portion in FIG. 3.

### Magnetic Flux of Rotating Electric Machine

The recess 36 is formed along the inner periphery 22b of the permanent magnet 22, thereby ensuring the hollow wall S between the outer peripheral edge 21a of the rotor core 21 and the stator 2. Therefore, magnetic flux is less likely to flow along the q axis, and a q-axis inductance can be reduced.

In addition, by forming the recess 36 along the inner periphery 22b of the permanent magnet 22, the amount of steel (iron) forming the rotor core 21 between the permanent magnet 22 and the teeth 13 on the q axis can be reduced. As a result, it is possible to increase magnetic flux saturation, thereby reducing iron loss.

Here, a ratio of the width W1 of the inner peripheral side rib 34 in the width W1 of the inner peripheral side rib 34 and the width W2 of the outer peripheral side rib 35, between which the permanent magnet 22 is sandwiched in the radial direction, satisfies the following expression:

(Ria−Rib)/[(Roa−Rob)+(Ria−Rib)]

In addition, the width W2 (Roa−Rob) of the outer peripheral side rib 35 is greater than 0 and equal to or less than 0.09 with respect to the outer diameter Rob of the outer periphery of the permanent magnet 22. That is, the width W2 of the outer peripheral side rib 35 and the outer diameter Rob of the outer periphery of the permanent magnet 22 satisfy the following relationship:

0<(Roa−Rob)/Rob≤0.09

Hereinafter, (Roa−Rob)/Rob will be represented as a ratio Rat. That is,

Ratio Rat=(Roa−Rob)/Rob
and

0<Ratio Rat≤0.09.

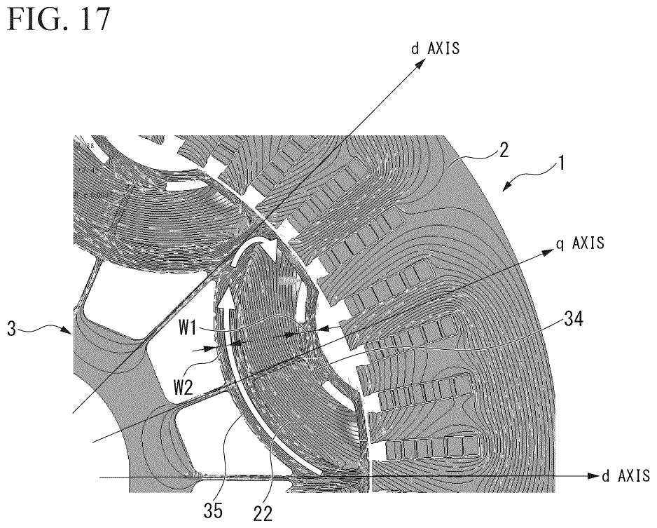

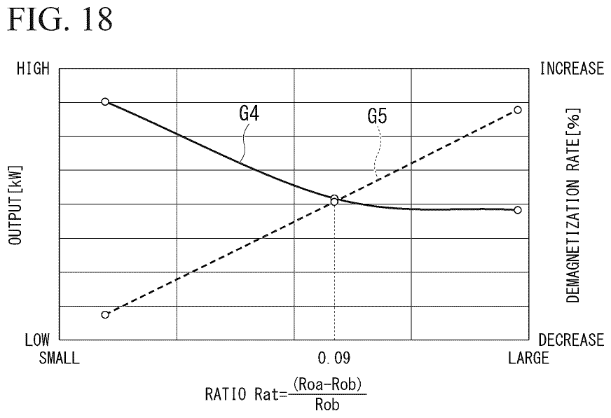

The reason why the width W2 (Roa−Rob) of the outer peripheral side rib 35 is set to be greater than 0 and equal to or less than 0.09 with respect to the outer diameter Rob of the outer periphery of the permanent magnet 22 will be described below with reference to FIGS. 17 and 18.

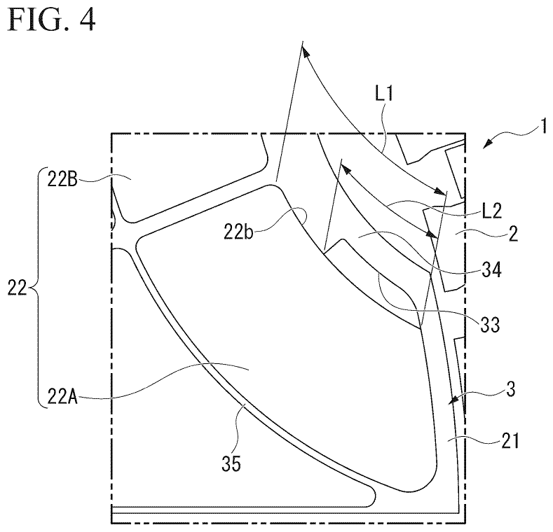

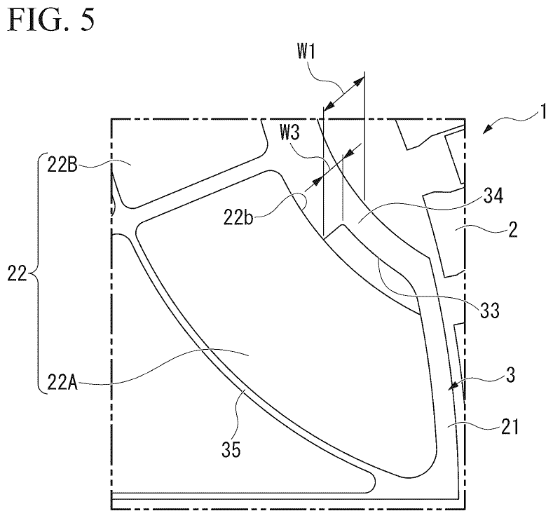

FIG. 4 is a cross-sectional view showing a length ratio of the flux barrier in the rotating electric machine. FIG. 5 is a cross-sectional view showing a width ratio of the flux barrier in the rotating electric machine.

As shown in FIGS. 4 and 5, a length ratio Ra1 of the flux barrier 33 and a width ratio Ra2 of the flux barrier 33 satisfy the following relationship:
Ra1≥Ra2

However,

Ra1=L2/L1
L1: Length of the inner periphery 22b of the permanent magnet 22 along the first magnet 22A or the second magnet 22B
L2: Length of the flux barrier 33 in contact with the end portion of the inner periphery 22b of the permanent magnet 22 Ra2=W3/W1
W1: Width of the inner peripheral side rib 34 in the radial direction
W3: Width of the flux barrier 33 in the radial direction

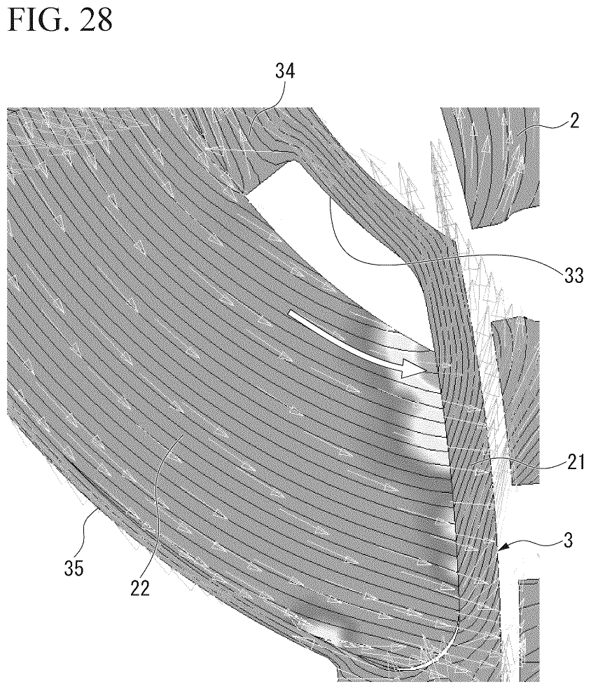

The reason why the length ratio Ra1 of the flux barrier 33 is set to be greater than the width ratio Ra2 of the flux barrier 33 will be described below with reference to FIGS. 28 to 32.

Next, the reason why the width W2 of the outer peripheral side rib 35 is set to be smaller than the width W1 of the inner peripheral side rib 34 will be described with reference to FIGS. 6 to 16.

First, the rotating electric machine 1 according to the embodiment will be described with reference to FIGS. 6 to 8.

FIG. 6 is a cross-sectional view showing the outer peripheral side rib and the inner peripheral side rib in the rotating electric machine according to the embodiment. As shown in FIG. 6, in the rotating electric machine 1 of the embodiment, the width W2 of the outer peripheral side rib 35 of the rotor 3 is formed to be smaller than the width W1 of the inner peripheral side rib 34.

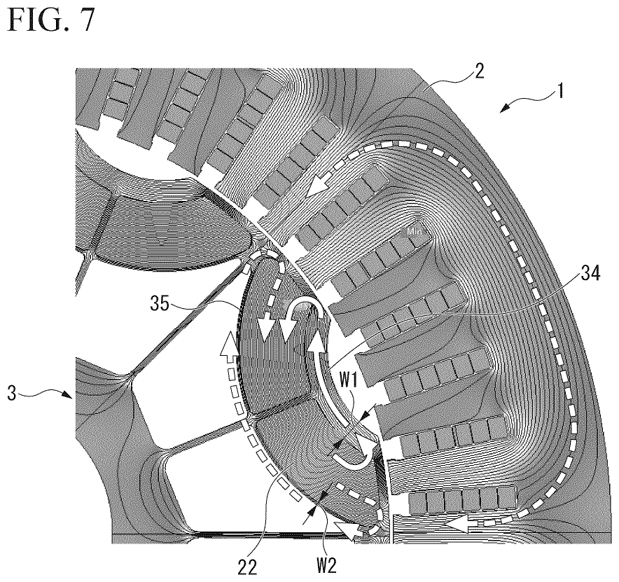

FIG. 7 is a cross-sectional view illustrating a magnetic flux flow during the low load in the rotating electric machine according to the embodiment. As shown in FIG. 7, in a case in which a q-axis applied current is kept small under the low load, by making the width W2 of the outer peripheral side rib 35 small, saturation with the magnetic flux of the magnet occurs in the outer peripheral side rib 35, as shown by an arrow. On the other hand, by increasing the width W1 of the inner peripheral side rib 34, the magnetic flux of the magnet can be easily short-circuited within the rotor 3 as shown by an arrow. As a result, it is possible to keep the amount of magnetic flux of the magnet acting on the stator 2 small, and thus it is possible to improve efficiency under the low load.

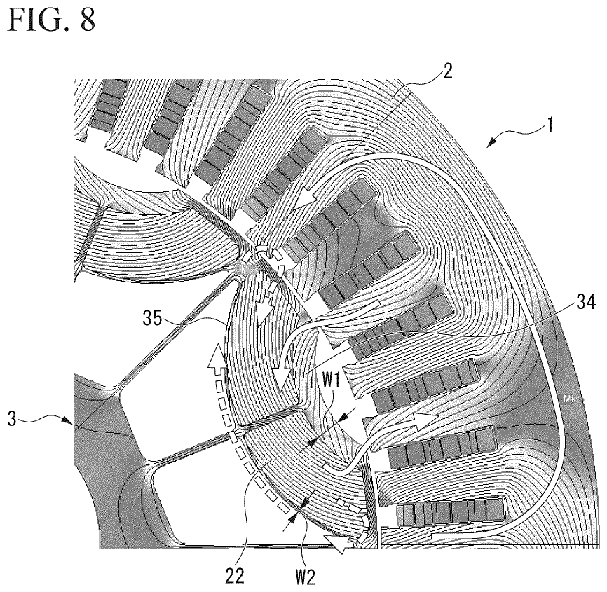

FIG. 8 is a cross-sectional view illustrating a magnetic flux flow during the high load in the rotating electric machine according to the embodiment. As shown in FIG. 8, a short-circuit path of the magnetic flux of the magnet is mainly the inner periphery of the permanent magnet 22. Therefore, in a case in which the q-axis applied current is increased under the high load, the short-circuit path on the inner peripheral side of the permanent magnet 22 changes as shown by an arrow due to excitation from the stator 2, and passes through the stator 2.

As a result, it is possible to increase the amount of magnetic flux of the magnet effectively acting on the q-axis applied current, and thus it is possible to ensure a high output (torque) during high speed rotation.

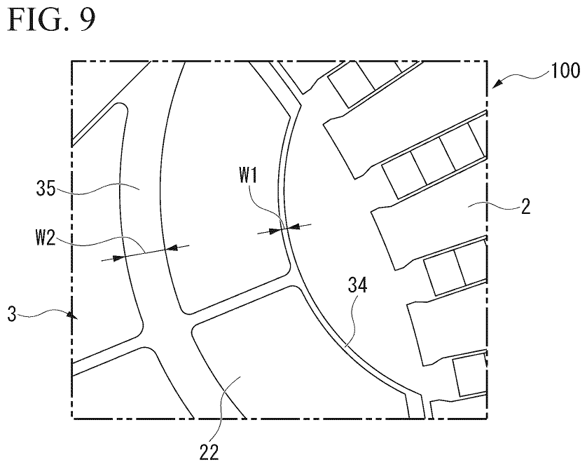

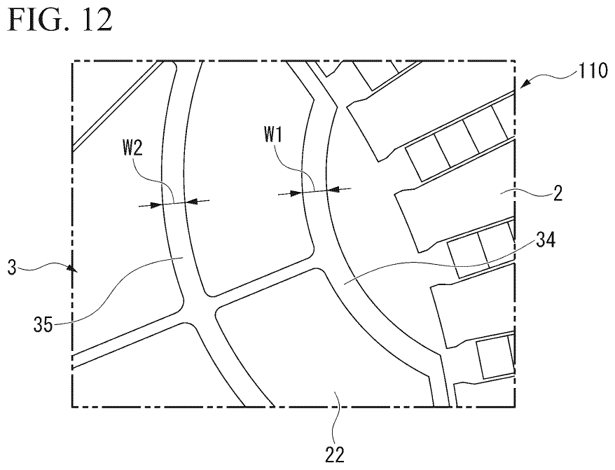

Next, a rotating electric machine 100 of Comparative Example 1 will be described with reference to FIGS. 9 to 11, and a rotating electric machine 110 of Comparative Example 2 will be described with reference to FIGS. 12 to 14. For convenience, the constituent elements of Comparative Example 1 and Comparative Example 2 will be described using the same reference numerals as those of the rotating electric machine 1 of the embodiment.

FIG. 9 is a cross-sectional view showing an outer peripheral side rib and an inner peripheral side rib in the rotating electric machine of Comparative Example 1. As shown in FIG. 9, in the rotating electric machine 100 of Comparative Example 1, the width W2 of the outer peripheral side rib 35 is formed to be greater than the width W1 of the inner peripheral side rib 34.

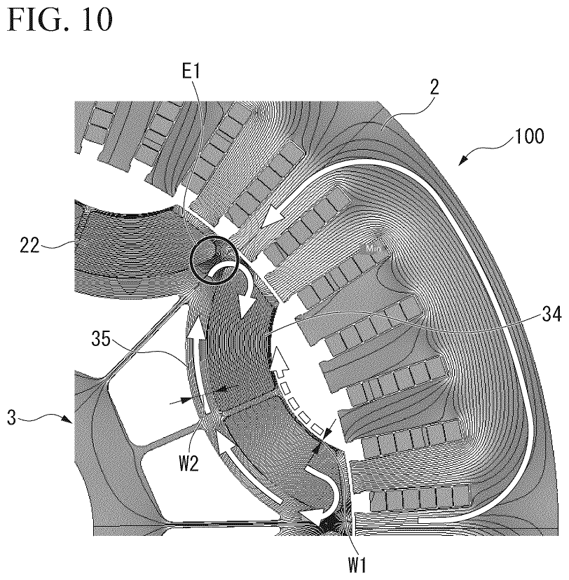

FIG. 10 is a cross-sectional view illustrating a magnetic flux flow during the low load in the rotating electric machine of Comparative Example 1. As shown in FIG. 10, in a case in which a q-axis applied current is kept small under the low load, by making the width W1 of the inner peripheral side rib 34 small, saturation occurs in a region E1 between the adjacent permanent magnets 22. Therefore, the amount of short circuit of the magnetic flux of the magnet in the rotor 3 is reduced. For this reason, the amount of magnetic flux of the magnet acting on the stator 2 is increased, and thus it is difficult to improve efficiency during the low load.

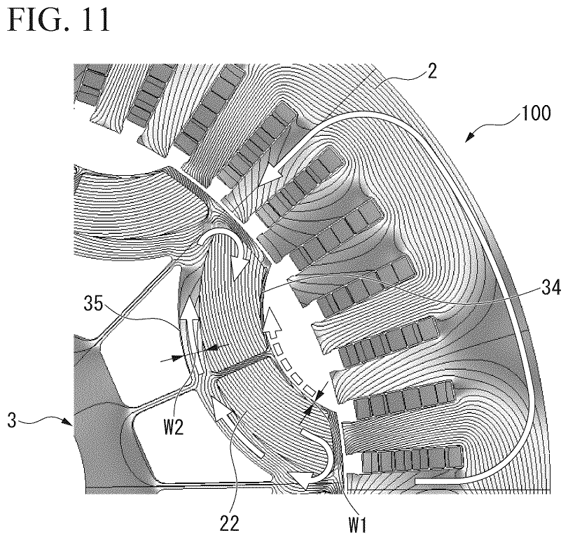

FIG. 11 is a cross-sectional view illustrating a magnetic flux flow during the high load in the rotating electric machine of Comparative Example 1. As shown in FIG. 11, a short-circuit path of the magnetic flux of the magnet is mainly the outer periphery of the permanent magnet 22. Therefore, in a case in which the q-axis applied current is increased under the high load, the influence of excitation from the stator 2 is small. That is, the amount of magnetic flux of the magnet hardly increases with respect to the q-axis applied current. For this reason, it is difficult to ensure a high output during high speed rotation.

FIG. 12 is a cross-sectional view showing an outer peripheral side rib and an inner peripheral side rib in the rotating electric machine of Comparative Example 2.

As shown in FIG. 12, in the rotating electric machine 110 of Comparative Example 2, the width W2 of the outer peripheral side rib 35 is formed to be relatively great, being the same as the width W1 of the inner peripheral side rib 34. The width W1 of the inner peripheral side rib 34 in the rotating electric machine 110 is smaller than the width W1 of the inner peripheral side rib 34 in the embodiment, for example.

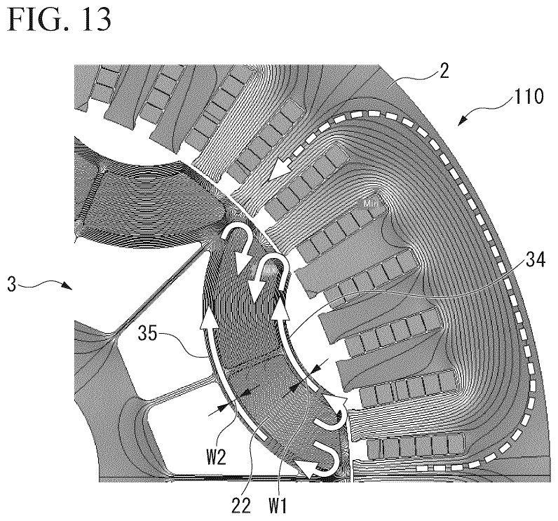

FIG. 13 is a cross-sectional view illustrating a magnetic flux flow during the low load in the rotating electric machine of Comparative Example 2. As shown in FIG. 13, in a case in which a q-axis applied current is kept small under the low load, the width W2 of the outer peripheral side rib 35 and the width W1 of the inner peripheral side rib 34 are formed to be relatively great, and thus the magnetic flux of the magnet is likely to short-circuit within the rotor 3 as shown by an arrow. As a result, it is possible to keep the amount of magnetic flux of the magnet acting on the stator 2 small, and thus it is possible to improve efficiency under the low load.

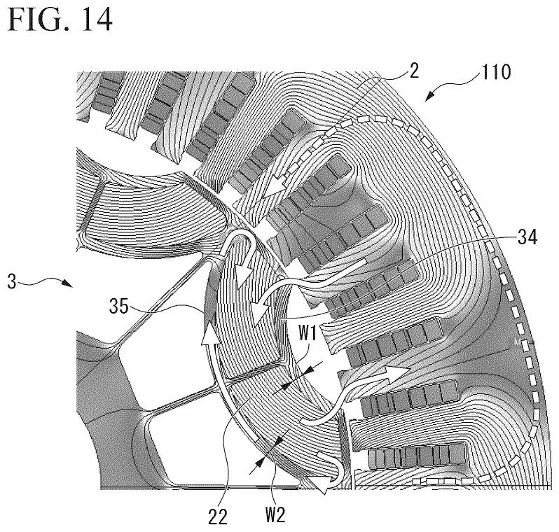

FIG. 14 is a cross-sectional view illustrating a magnetic flux flow during the high load in the rotating electric machine of Comparative Example 2. As shown in FIG. 14, a short-circuit path of the magnetic flux of the magnet is present on the inner periphery and the outer periphery of the permanent magnet 22. According to the rotating electric machine 110, in a case in which the q-axis applied current is increased under the high load, only the inner periphery of the permanent magnet 22 is affected by the excitation from the stator 2. Therefore, it is expected that the amount of magnetic flux of the magnet that can be effectively extracted in response to the q-axis applied current will increase.

Here, the width W1 of the inner peripheral side rib 34 in Comparative Example 2 is smaller than the width W1 of the inner peripheral side rib 34 in the embodiment, for example. Therefore, in the case of the rotating electric machine 110 of Comparative Example 2, the amount of magnetic flux of the magnet is smaller than that of the rotating electric machine 1 of the embodiment. For this reason, in Comparative Example 2, the output during high speed rotation is smaller than that of the embodiment.

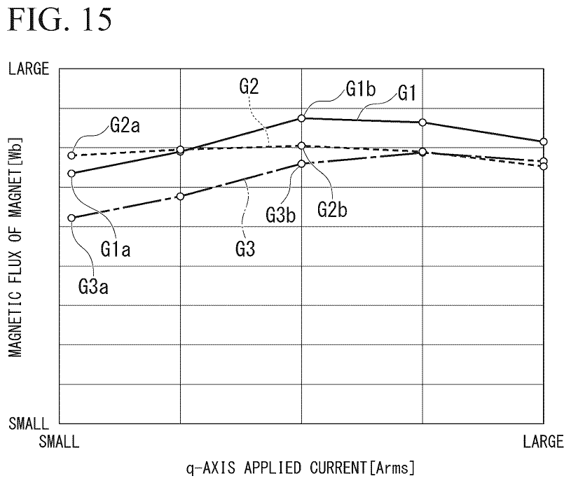

Next, a relationship between the q-axis applied current and the magnetic flux of the magnet in the embodiment, Comparative Example 1, and Comparative Example 2 will be described with reference to a graph in FIG. 15.

FIG. 15 is a graph showing changes in magnetic flux of the magnet with respect to the q-axis applied current in the rotating electric machine of the embodiment, the rotating electric machine of Comparative Example 1, and the rotating electric machine of Comparative Example 2.

In FIG. 15, a vertical axis represents the magnetic flux of the magnet. A horizontal axis represents the q-axis applied current. A graph G1 shows the rotating electric machine 1 of the embodiment, a graph G2 shows the rotating electric machine 100 of Comparative Example 1, and a graph G3 shows the rotating electric machine 110 of Comparative Example 2.

As shown in FIGS. 7 and 15, in the graph G1 of the embodiment, in a case in which the q-axis applied current is kept small under the low load, the magnetic flux of the magnet at G1a is small. Therefore, the rotating electric machine 1 of the embodiment can improve efficiency by keeping the amount of magnetic flux of the magnet small.

In addition, as shown in FIGS. 8 and 15, in the graph G1 of the embodiment, in a case in which the q-axis applied current is increased under the high load, the magnetic flux of the magnet at G1b is increased. Therefore, the rotating electric machine 1 of the embodiment can ensure a high output during high speed rotation by increasing the amount of magnetic flux of the magnet.

As shown in FIGS. 10 and 15, in the graph G2 of Comparative Example 1, in a case in which the q-axis applied current is kept small under the low load, the magnetic flux of the magnet at G2a is large. Therefore, in the rotating electric machine 100 of Comparative Example 1, it is difficult to improve efficiency during the low load due to the increase in the amount of magnetic flux of the magnet.

In addition, as shown in FIGS. 11 and 15, in the graph G2 of Comparative Example 1, in a case in which the q-axis applied current is increased under the high load, the magnetic flux of the magnet at G2b is hardly increased compared to the magnetic flux of the magnet at G2a. For this reason, it is difficult for the rotating electric machine 100 of Comparative Example 1 to ensure a high output during high speed rotation.

As shown in FIGS. 13 and 15, in the graph G3 of Comparative Example 2, in a case in which the q-axis applied current is kept small under the low load, the magnetic flux of the magnet at G3a is small. Therefore, the rotating electric machine 110 of Comparative Example 2 can improve efficiency by keeping the amount of magnetic flux of the magnet small.

On the other hand, as shown in FIGS. 14 and 15, in the graph G3 of Comparative Example 2, in a case in which the q-axis applied current is increased under the high load, the magnetic flux of the magnet at G3b is smaller than that at G1b of the embodiment. For this reason, it is difficult for the rotating electric machine 110 of Comparative Example 2 to ensure a high output during high speed rotation.

As described above, in the rotating electric machine 1 of the embodiment, by making the width W2 of the outer peripheral side rib 35 smaller than the width W1 of the inner peripheral side rib 34, it is possible to improve efficiency under the low load and ensure a high output under the low load.

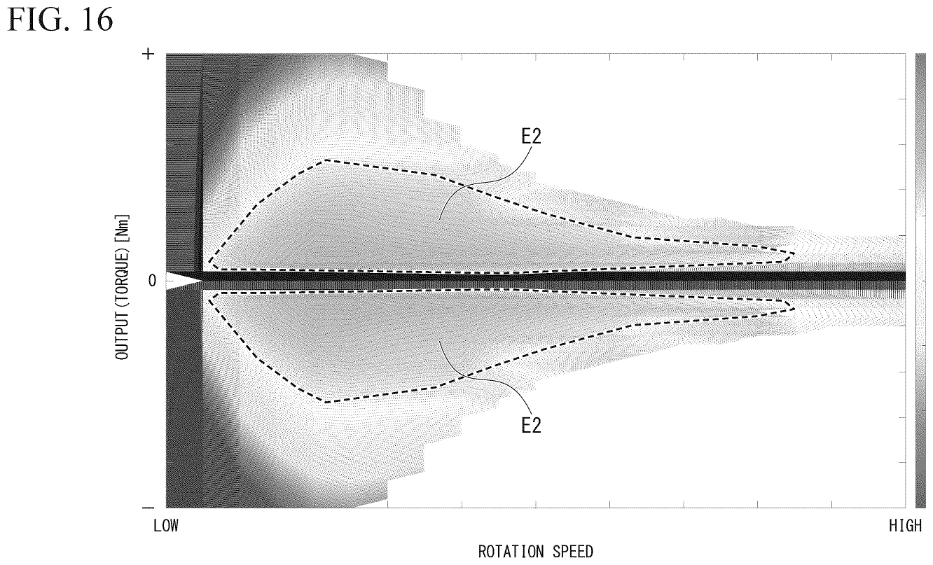

FIG. 16 is a graph showing an efficiency map of the rotating electric machine according to the embodiment.

In FIG. 16, a vertical axis represents the output (torque) [Nm] of the rotating electric machine 1. A horizontal axis represents the rotation speed [rpm] of the rotating electric machine 1. E2 indicates an efficient region of the rotating electric machine 1.

As shown in FIG. 16, when the magnetic flux of the magnet at low load is reduced, iron loss and AC copper loss are kept low in a low load region, and the current to be applied for field weakening is reduced. Therefore, DC copper loss is reduced in a high speed rotation region. As a result, it is possible to improve the efficiency in the low load region in a medium rotation or higher range in which a driving frequency of the rotating electric machine 1 is high.

Next, the reason why the width W2 (Roa−Rob) of the outer peripheral side rib 35 is set to be greater than 0 and equal to or less than 0.09 with respect to the outer diameter Rob of the outer periphery of the permanent magnet 22 will be described with reference to FIGS. 17 and 18.

FIG. 17 is a cross-sectional view showing the amount of magnetic flux from the outer periphery of the permanent magnet in the rotating electric machine according to the embodiment.

As shown in FIGS. 3 and 17, the width W2 of the outer peripheral side rib 35 is selected to be smaller than the width W1 of the inner peripheral side rib 34. Here, for example, in a case in which the width W2 of the outer peripheral side rib 35 is increased, the magnetic flux on a d axis flows easily, and a d-axis inductance is increased. For this reason, the output (torque) of the rotating electric machine 1 during high speed rotation is decreased.

In addition, for example, in a case in which the width W2 of the outer peripheral side rib 35 is increased, the magnetic flux from the stator 2 flows at the outer periphery of the permanent magnet 22 as shown by an arrow in a field-weakening region. For this reason, the amount of magnetic flux from the outer periphery of the permanent magnet 22 is increased, and a reverse magnetic field that is applied to the permanent magnet 22 is increased.

Here, the width W2 (Roa−Rob) of the outer peripheral side rib 35 is selected to be greater than 0 and equal to or less than 0.09 with respect to the outer diameter Rob of the outer periphery of the permanent magnet 22.

That is,
0<Ratio Rat≤0.09 and

Ratio Rat=(Roa−Rob)/Rob.

FIG. 18 is a graph illustrating relationships of an output and a demagnetization rate with respect to a width of the outer peripheral side rib in the rotating electric machine.

In FIG. 18, a vertical axis represents the output [kW] and the demagnetization rate [%] of the rotating electric machine 1. A horizontal axis represents the ratio Rat. A graph G4 shows the output of the rotating electric machine 1. A graph G5 shows the demagnetization rate of the rotating electric machine 1.

As shown in FIG. 18, in the graph G4, the ratio Rat is reduced from 0.09 to 0, and the output [kW] of the rotating electric machine 1 is improved. In the graph G5, the ratio Rat is reduced from 0.09 to 0, and the demagnetization rate [%] of the permanent magnet 22 is reduced.

On the other hand, in the graph G4, the ratio Rat is increased to be greater than 0.09, and the output [kW] of the rotating electric machine 1 is decreased. In the graph G5, the ratio Rat is increased to be greater than 0.09, and the demagnetization rate [%] of the permanent magnet 22 is increased.

Therefore, the width W2 (Roa−Rob) of the outer peripheral side rib 35 is selected to be greater than 0 and equal to or less than 0.09 with respect to the outer diameter Rob of the outer periphery of the permanent magnet 22. As a result, it is possible to improve the output of the rotating electric machine 1 and to reduce the demagnetization rate of the permanent magnet 22.

Here, the outer peripheral side rib 35 is formed of, for example, a non-magnetic steel plate. As a result, it is possible to prevent the d-axis inductance from becoming excessive, to reduce the magnetic flux density from the outer peripheral side rib 35, and to improve the demagnetization resistance performance.

Next, the reason for providing the flux barrier 33 at the end portion of the inner peripheral side rib 34 will be described with reference to FIGS. 19 to 27.

Here, unlike a reverse saliency motor, in a normal saliency motor, demagnetization is likely to occur in the field-weakening region. That is, in the normal saliency motor, by advancing a current advance angle, the magnetic field from the stator 2 is applied in a direction opposite to a magnet orientation direction. In this state, the orientation direction is likely to change at the corner portions of the permanent magnet 22 due to the reverse magnetic field, and thus demagnetization is likely to occur. Therefore, in order to ensure the demagnetization resistance performance of the permanent magnet 22, the shape of the flux barrier 33 at the corner portions of the permanent magnet 22 becomes important.

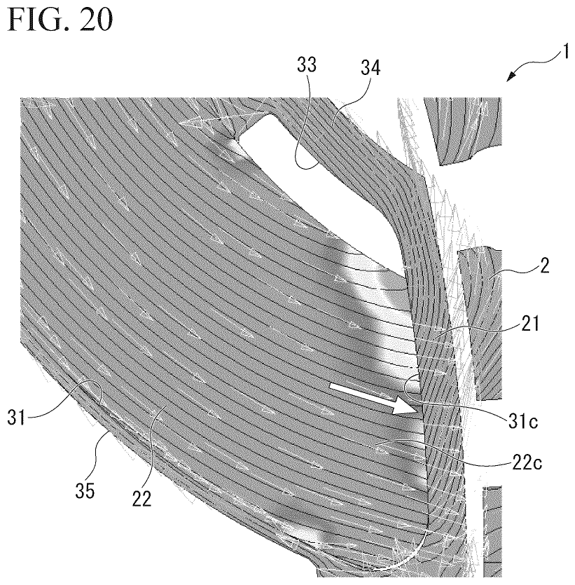

First, the rotating electric machine 1 according to the embodiment will be described with reference to FIGS. 19 and 20.

FIG. 19 is a cross-sectional view showing the rotor core and the permanent magnet in the rotating electric machine according to the embodiment. As shown in FIG. 19, in the rotating electric machine 1 of the embodiment, the flux barrier 33 is provided at the end portion of the inner peripheral side rib 34. That is, at the end portion of the inner peripheral side rib 34, a hollow wall caused by the flux barrier 33 is provided between the permanent magnet 22 and the end portion of the inner peripheral side rib 34. In addition, the end portion 22c of the permanent magnet 22 is in contact with the end portion 31c of the magnet insertion hole 31. That is, the end portion 22c of the permanent magnet 22 is in contact with the rotor core 21.

FIG. 20 is a cross-sectional view showing a flow of the magnetic flux in the rotating electric machine of the embodiment.

As shown in FIG. 20, in the rotating electric machine 1 of the embodiment, since the hollow wall caused by the flux barrier 33 is provided between the permanent magnet 22 and the end portion of the inner peripheral side rib 34, it is possible to increase the magnetic resistance. In addition, since the end portion 22c of the permanent magnet 22 is in contact with the rotor core 21, it is possible to reduce the magnetic resistance. Therefore, the magnetic flux flows very easily in the magnetization direction as shown by an arrow. As a result, it is possible to improve the demagnetization resistance performance against the reverse magnetic field from an external magnetic field.

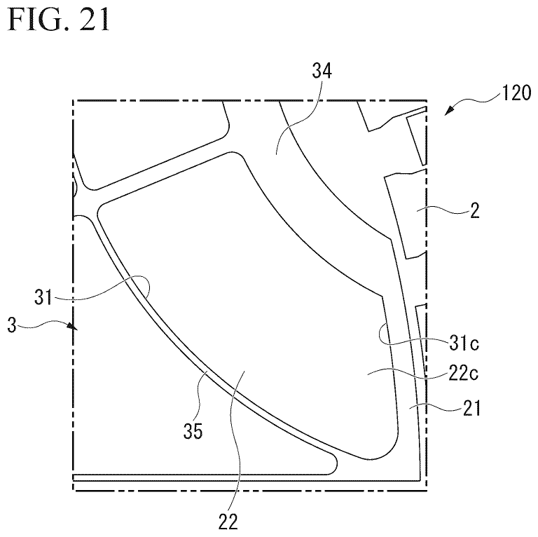

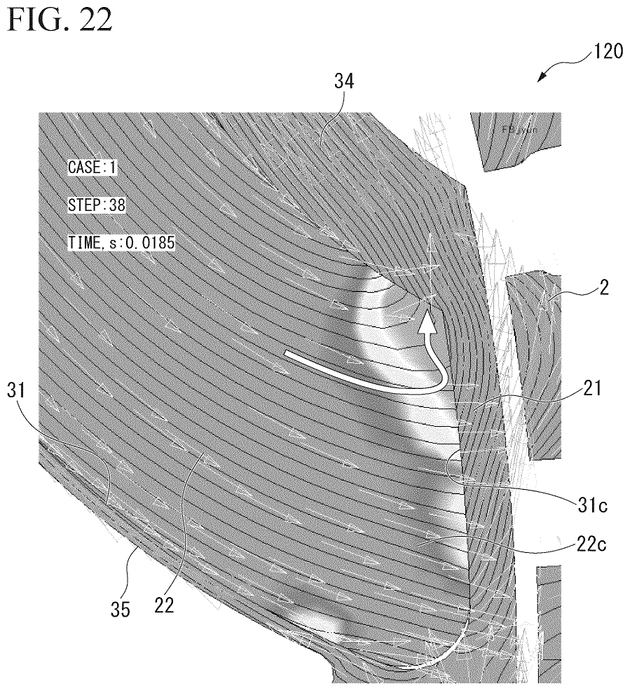

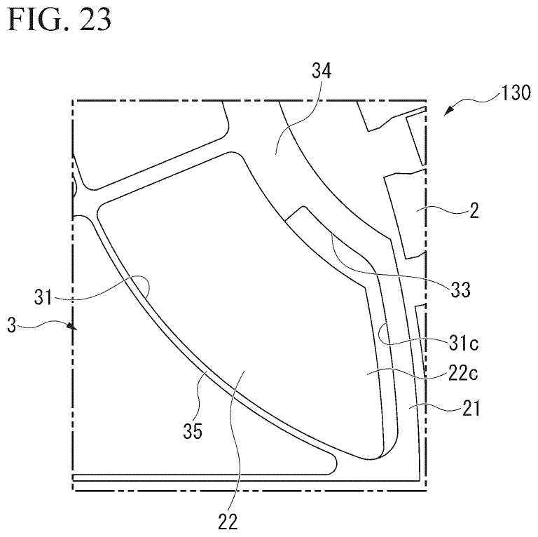

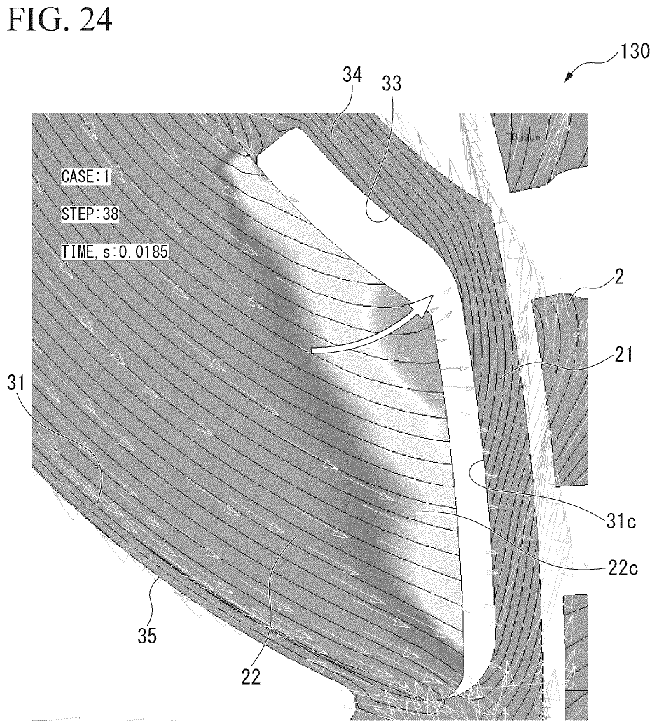

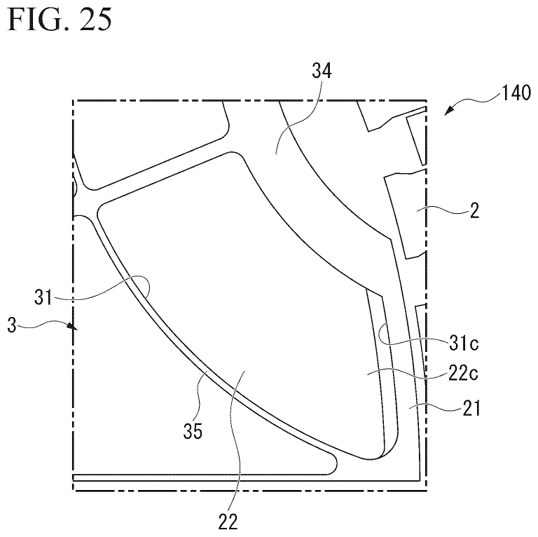

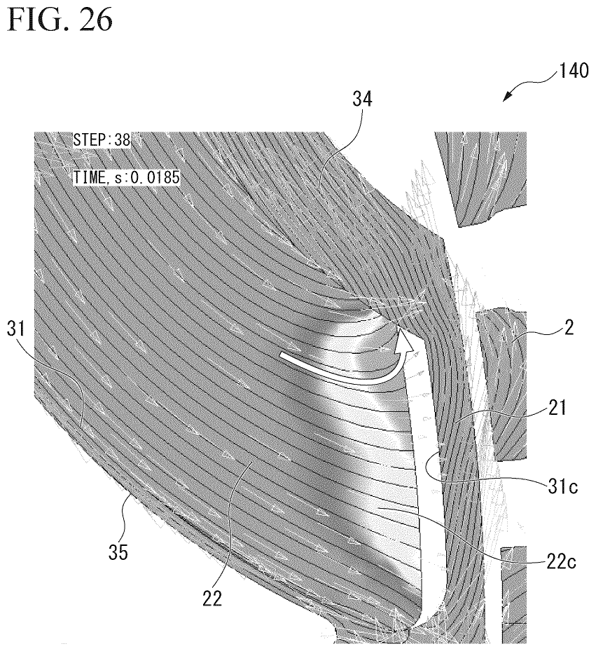

Next, a rotating electric machine 120 of Comparative Example 3 will be described with reference to FIGS. 21 and 22, and a rotating electric machine 130 of Comparative Example 4 will be described with reference to FIGS. 23 and 24. In addition, a rotating electric machine 140 of Comparative Example 5 will be described with reference to FIGS. 25 and 26. For convenience, the constituent elements of Comparative Example 3 to Comparative Example 5 will be described using the same reference numerals as those of the rotating electric machine 1 of the embodiment.

FIG. 21 is a cross-sectional view showing a rotor core and a permanent magnet in a rotating electric machine of Comparative Example 3. As shown in FIG. 21, in the rotating electric machine 120 of Comparative Example 3, the flux barrier 33 is provided at the end portion of the inner peripheral side rib 34. That is, the permanent magnet 22 is in contact with the end portion of the inner peripheral side rib 34. In addition, the end portion 22c of the permanent magnet 22 is in contact with the end portion 31c of the magnet insertion hole 31. That is, the end portion 22c of the permanent magnet 22 is in contact with the rotor core 21.

FIG. 22 is a cross-sectional view showing a flow of the magnetic flux in the rotating electric machine of Comparative Example 3.

As shown in FIG. 22, in the rotating electric machine 120 of Comparative Example 3, since the permanent magnet 22 is in contact with the end portion of the inner peripheral side rib 34, the magnetic resistance is low. In addition, since the end portion 22c of the permanent magnet 22 is in contact with the rotor core 21, the magnetic resistance is low. Therefore, the magnetization direction at the end portion 22c of the permanent magnet 22 is affected by the reverse magnetic field as shown by an arrow. For this reason, the magnetic flux is likely to change due to the reverse magnetic field from the external magnetic field, and thus demagnetization is likely to occur.

FIG. 23 is a cross-sectional view showing a rotor core and a permanent magnet in a rotating electric machine of Comparative Example 4. As shown in FIG. 23, in the rotating electric machine 130 of Comparative Example 4, a hollow wall caused by the flux barrier 33 is provided between the permanent magnet 22 and the end portion of the inner peripheral side rib 34. In addition, the end portion 22c of the permanent magnet 22 is not in contact with the end portion 31c of the magnet insertion hole 31 (that is, the rotor core 21).

FIG. 24 is a cross-sectional view showing a flow of the magnetic flux in the rotating electric machine of Comparative Example 4.

As shown in FIG. 24, in the rotating electric machine 130 of Comparative Example 4, by providing the hollow wall caused by the flux barrier 33 between the permanent magnet 22 and the end portion of the inner peripheral side rib 34, and the magnetic resistance is high. In addition, since the end portion 22c of the permanent magnet 22 is not in contact with the rotor core 21, the magnetic resistance is high. Therefore, the magnetization direction at the end portion 22c of the permanent magnet 22 becomes unstable as shown by an arrow. For this reason, the magnetic flux is likely to be demagnetized due to the reverse magnetic field from the external magnetic field.

FIG. 25 is a cross-sectional view showing a rotor core and a permanent magnet in a rotating electric machine of Comparative Example 5. As shown in FIG. 25, in the rotating electric machine 140 of Comparative Example 5, the flux barrier 33 is provided at the end portion of the inner peripheral side rib 34. That is, the permanent magnet 22 is in contact with the end portion of the inner peripheral side rib 34. In addition, the end portion 22c of the permanent magnet 22 is not in contact with the end portion 31c of the magnet insertion hole 31 (that is, the rotor core 21).

FIG. 26 is a cross-sectional view showing a flow of the magnetic flux in the rotating electric machine of Comparative Example 5.

As shown in FIG. 26, in the rotating electric machine 140 of Comparative Example 5, since the permanent magnet 22 is in contact with the end portion of the inner peripheral side rib 34, the magnetic resistance is low. In addition, since the end portion 22c of the permanent magnet 22 is not in contact with the rotor core 21, the magnetic resistance is high. Therefore, the magnetic resistance on the inner peripheral side of the end portion 22c of the permanent magnet 22 is low. For this reason, the magnetic flux is likely to change due to the reverse magnetic field from the external magnetic field, and demagnetization is likely to occur.

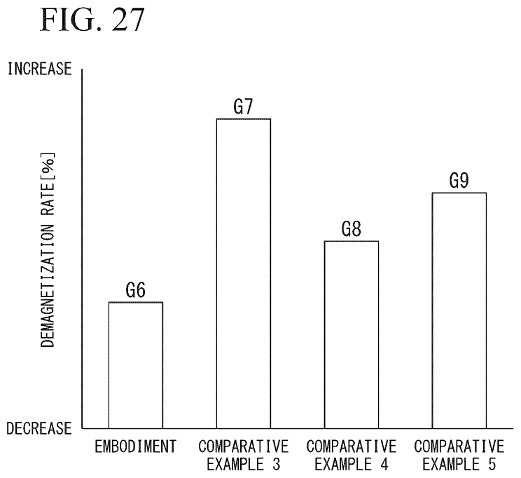

FIG. 27 is a graph illustrating the demagnetization rates of the embodiment and Comparative Example 3 to Comparative Example 5. In FIG. 27, a vertical axis represents the demagnetization rate [%]. A graph G6 shows the demagnetization rate in the rotating electric machine 1 according to the embodiment. A graph G7 shows the demagnetization rate in the rotating electric machine 120 according to Comparative Example 3. A graph G8 shows the demagnetization rate in the rotating electric machine 130 according to Comparative Example 4. A graph G9 shows the demagnetization rate in the rotating electric machine 140 according to Comparative Example 5.

As shown in FIGS. 19, 20, and 27, the graph G6 of the embodiment shows the greatest reduction in demagnetization rate. That is, in the rotating electric machine 1 of the embodiment, the hollow wall caused by the flux barrier 33 is provided between the permanent magnet 22 and the end portion of the inner peripheral side rib 34, and the end portion 22c of the permanent magnet 22 is in contact with the rotor core 21. As a result, it is possible to maximize the demagnetization resistance performance in the permanent magnet 22.

As shown in FIGS. 21, 22, and 27, the graph G7 of Comparative Example 3 shows the greatest increase in demagnetization rate. That is, in the rotating electric machine 120 of Comparative Example 3, the permanent magnet 22 is in contact with the end portion of the inner peripheral side rib 34, and the end portion 22c of the permanent magnet 22 is in contact with the rotor core 21. For this reason, the magnetic flux is likely to change due to the reverse magnetic field from the external magnetic field, and thus demagnetization is most likely to occur.

As shown in FIGS. 23, 24, and 27, the graph G8 of Comparative Example 4 shows that the demagnetization rate is higher than that in the graph G6 of the embodiment. That is, in the rotating electric machine 130 of Comparative Example 4, the hollow wall caused by the flux barrier 33 is provided between the permanent magnet 22 and the end portion of the inner peripheral side rib 34, and the end portion 22c of the permanent magnet 22 is not in contact with the rotor core 21. For this reason, the demagnetization is more likely to occur due to the reverse magnetic field from the external magnetic field than in the graph G6 of the embodiment.

As shown in FIGS. 25 to 27, the demagnetization rate in the graph G9 of the Comparative Example 5 is higher than that in the graph G8 of the Comparative Example 4. That is, in the rotating electric machine 140 of Comparative Example 5, the permanent magnet 22 is in contact with the end portion of the inner peripheral side rib 34, and the end portion 22c of the permanent magnet 22 is not in contact with the rotor core 21. For this reason, the magnetic flux is likely to change due to the reverse magnetic field from the external magnetic field, and thus demagnetization is more likely to occur than in the graph G8 of Comparative Example 4.

As shown in FIGS. 19 to 27, in the rotating electric machine 1 of the embodiment, the flux barrier 33 is provided at the end portion of the inner peripheral side rib 34, and the end portion 22c of the permanent magnet 22 is in contact with the end portion 31c of the magnet insertion hole 31. As a result, in the rotating electric machine 1 of the embodiment, it is possible to improve the demagnetization resistance performance of the permanent magnet 22 compared to those of the rotating electric machine 120 of Comparative Example 3, the rotating electric machine 130 of Comparative Example 4, and the rotating electric machine 140 of Comparative Example 5.

Next, the reason why the length ratio Ra1 of the flux barrier 33 is set to be greater than the width ratio Ra2 of the flux barrier 33 will be described with reference to FIGS. 28 to 32. Hereinafter, the length ratio Ra1 of the flux barrier 33 may be referred to as a “length ratio Ra1,” and the width ratio Ra2 of the flux barrier 33 may be referred to as a “width ratio Ra2.” In first to fourth examples shown in FIGS. 28 to 32, the same reference numerals will be used for the flux barriers 33 for convenience of explanation.

FIG. 28 is a cross-sectional view showing a magnetic flux flow in the first example of the flux barrier.

As shown in FIGS. 4, 5 and 28, in the flux barrier 33 of the first example, Ra1 (L2/L1) is 0.6 and Ra2 (W3/W1) is 0.6. That is, in the flux barrier 33 of the first example, each of the length ratio Ra1 and the width ratio Ra2 is large. In addition, the flux barrier 33 of the first example satisfies the relationship Ra1≥Ra2.

According to the flux barrier 33 of the first example, it is possible to suppress a vector change in a direction in which the magnetic flux of the magnet in the permanent magnet 22 is short-circuited due to the reverse magnetic field. As a result, it is possible to allow the magnetic flux to flow very easily in the magnetization direction as shown by an arrow. Therefore, it is possible to improve the demagnetization resistance performance against the reverse magnetic field from the external magnetic field.

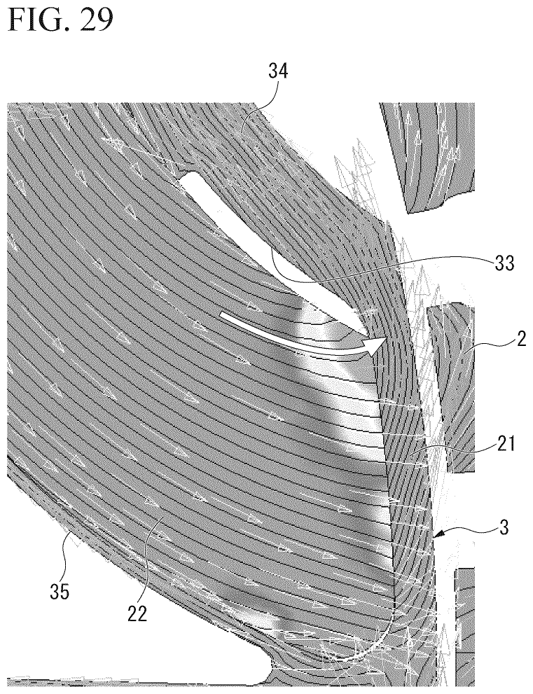

FIG. 29 is a cross-sectional view showing a magnetic flux flow in the second example of the flux barrier.

As shown in FIGS. 4, 5 and 29, in the flux barrier 33 of the second example, Ra1 (L2 /L1) is 0.6 and Ra2 (W3/W1) is 0.2. In addition, the flux barrier 33 of the second example satisfies the relationship Ra1≥Ra2.

According to the flux barrier 33 of the second example, it is possible to suppress a vector change in a direction in which the magnetic flux of the magnet in the permanent magnet 22 is short-circuited due to the reverse magnetic field. As a result, it is possible to allow the magnetic flux to flow very easily in the magnetization direction as shown by an arrow. Therefore, it is possible to improve the demagnetization resistance performance against the reverse magnetic field from the external magnetic field.

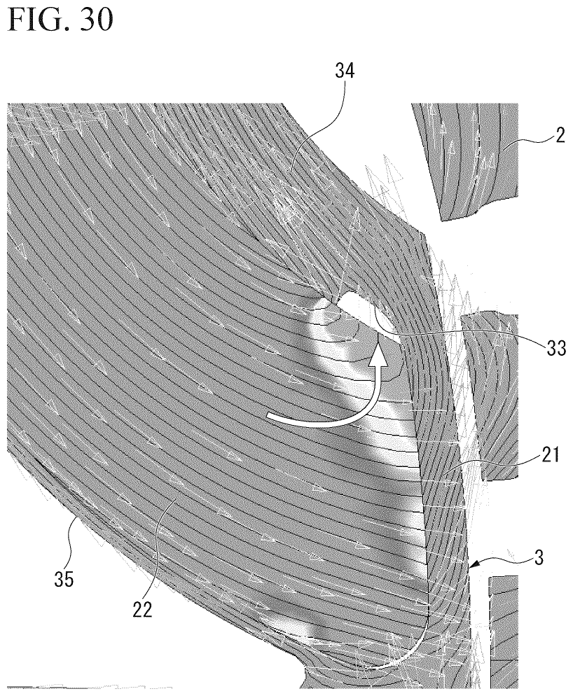

FIG. 30 is a cross-sectional view showing a magnetic flux flow in the third example of the flux barrier.

As shown in FIGS. 4, 5 and 30, in the flux barrier 33 of the third example, Ra1 (L2/L1) is 0.2 and Ra2 (W3/W1) is 0.2. In the flux barrier 33 of the third example, the length ratio Ra1 and the width ratio Ra2 are small. In addition, the flux barrier 33 of the third example satisfies the relationship Ra1≥Ra2.

According to the flux barrier 33 of the third example, although it is conceivable that the magnetic flux of the magnet in the permanent magnet 22 may be subjected to a vector change in a direction of short-circuiting as shown by an arrow due to the reverse magnetic field, a certain degree of demagnetization resistance performance against the reverse magnetic field from the external magnetic field can be ensured.

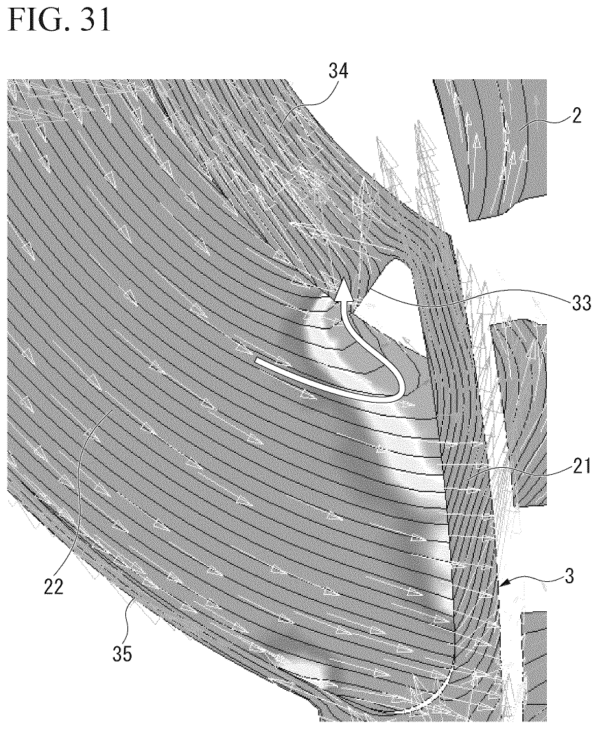

FIG. 31 is a cross-sectional view showing a magnetic flux flow in the fourth example of the flux barrier.

As shown in FIGS. 4, 5 and 31, in the flux barrier 33 of the fourth example, Ra1 (L2/L1) is 0.2 and Ra2 (W3/W1) is 0.6. In addition, the flux barrier 33 of the fourth example does not satisfy the relationship Ra1≥Ra2.

According to the flux barrier 33 of the fourth example, the magnetic flux of the magnet in the permanent magnet 22 is subjected to a vector change in a direction of short-circuiting as shown by an arrow due to the reverse magnetic field. For this reason, the magnetic flux of the magnet in the permanent magnet 22 is likely to be demagnetized due to the reverse magnetic field from the external magnetic field.

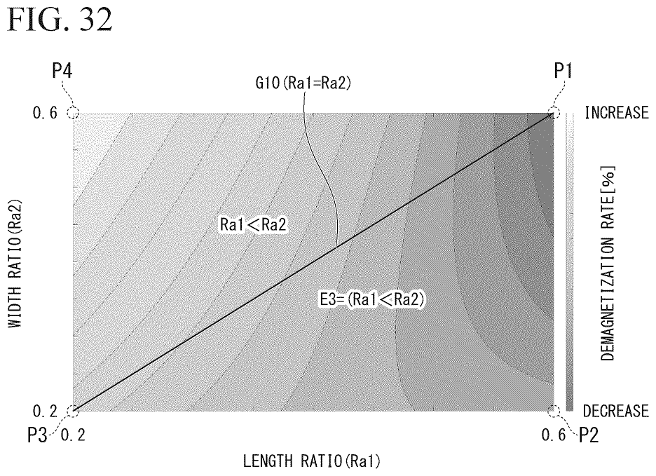

FIG. 32 is a graph showing a relationship between the length ratio and the width ratio in the flux barrier according to the embodiment.

In FIG. 32, a vertical axis represents the width ratio Ra2. A horizontal axis represents the length ratio Ra1. In addition, the vertical axis represents the demagnetization rate [%]. G10 shows a straight line that satisfies Ra1=Ra2. E3 partitioned by a straight line of G10 is a region in which Ra1>Ra2. In the straight line of G10 and the region E3, it is possible to ensure the demagnetization resistance performance of the permanent magnet 22. That is, in Ra1≥Ra2, it is possible to ensure the demagnetization resistance performance of the permanent magnet 22.

P1 indicates the positions of Ra1 and Ra2 in the first example. P2 indicates the positions of Ra1 and Ra2 in the second example. P3 indicates the positions of Ra1 and Ra2 in the third example. P4 indicates the positions of Ra1 and Ra2 in the fourth example.

As shown in FIGS. 28 and 32, P1 in the first example is located on the straight line of G10. Therefore, in the first example, since the relationship Ra1≥Ra2 of the embodiment is satisfied, it is possible to ensure the demagnetization resistance performance of the permanent magnet 22.

As shown in FIGS. 29 and 32, P2 in the second example is located in the region E3. Therefore, in the second example, since the relationship Ra1≥Ra2 of the embodiment is satisfied, it is possible to ensure the demagnetization resistance performance of the permanent magnet 22.

As shown in FIGS. 30 and 32, P3 in the third example is located on the straight line of G10. Therefore, in the third example, since the relationship Ra1≥Ra2 of the embodiment is satisfied, it is possible to ensure a certain degree of the demagnetization resistance performance of the permanent magnet 22.

As shown in FIGS. 31 and 32, P4 in the fourth example is located outside the region E3. Therefore, in the fourth example, since the relationship Ra1≥Ra2 of the embodiment is not satisfied, the magnetic flux of the magnet in the permanent magnet 22 is likely to be demagnetized.

According to the rotating electric machine 1 according to the embodiment described above, as shown in FIG. 3, the inner peripheral side rib 34 is formed on a side of the stator 2 in the magnet insertion hole 31. Therefore, the inner peripheral side rib 34 is formed on the inner peripheral side of the permanent magnet 22. In addition, the outer peripheral side rib 35 is formed so as to partition the gap 32 from the magnet insertion hole 31 and to be in contact with the permanent magnet 22. Therefore, the outer peripheral side rib 35 is formed on the outer peripheral side of the permanent magnet 22.

Here, the larger the proportion of the steel plate width on the inner peripheral side of the permanent magnet 22, the more likely it is that the magnetic flux of the magnet can be changed with respect to the q-axis applied current. Therefore, the width of the outer peripheral side rib 35 is made smaller than the width of the inner peripheral side rib 34. Therefore, it is possible to change the magnetic flux of the magnet in the permanent magnet 22 with respect to the q-axis applied current. As a result, in the case of the low load, the q-axis applied current is kept small, and the magnetic flux of the magnet is kept small, and thus it is possible to improve efficiency. In addition, in the case of the high load, it is possible to ensure a high output at high speed rotation by increasing the q-axis applied current to increase the magnetic flux of the magnet.

In addition, the ratio of the width W2 (Roa−Rob) of the outer peripheral side rib 35 to the outer diameter Rob of the outer periphery of the permanent magnet 22 is set to be greater than 0 and equal to or less than 0.09. As a result, it is possible to improve the output of the rotating electric machine 1 and to reduce the demagnetization rate of the permanent magnet 22.

Furthermore, the outer peripheral side rib 35 is formed of a non-magnetic steel plate. As a result, it is possible to prevent the d-axis inductance from becoming excessive, to reduce the magnetic flux density from the outer peripheral side rib 35, and to improve the demagnetization resistance performance.

In addition, the flux barrier 33 is provided at the end portion of the magnet insertion hole 31 on a side of the inner periphery 31b. In addition, the end portion 22c of the permanent magnet 22 is in contact with the end portion 31c of the magnet insertion hole 31. As a result, it is possible to increase the demagnetization resistance performance in the permanent magnet 22.

Furthermore, as shown in FIGS. 4 and 5, the ratio (Ra1=L2/L1) of the length L1 along the arc-shaped permanent magnet 22 to the length L2 of the flux barrier 33, and the ratio (Ra2=W3/W1) of the width W1 of the inner peripheral side rib 34 to the width W3 of the flux barrier 33 are set to Ra1≥Ra2.

Therefore, it is possible to suppress a vector change in a direction in which the magnetic flux of the magnet is short-circuited due to the reverse magnetic field. As a result, it is possible to improve the demagnetization resistance performance in the permanent magnet 22.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A rotating electric machine comprising:
a stator formed by slots into which a winding wire is inserted and teeth that form the slots;
a magnet having an arc shape recessed relative to the stator and having a magnetization direction formed in a circumferential direction along the arc shape;
a rotor having a magnet insertion hole into which the magnet is inserted and a recess formed on an outer peripheral edge along the magnet;
a gap provided on a side opposite to the stator with respect to the magnet insertion hole;
an inner peripheral side rib formed on a side of the stator in the magnet insertion hole; and
an outer peripheral side rib that partitions the gap from the magnet insertion hole and is in contact with the magnet,
wherein a width of the outer peripheral side rib is smaller than a width of the inner peripheral side rib.

2. The rotating electric machine according to claim 1, wherein the width of the outer peripheral side rib is greater than 0 and equal to or less than 0.09 with respect to an outer diameter of an outer periphery of the magnet on a side opposite to the stator.

3. The rotating electric machine according to claim 1, wherein the outer peripheral side rib is formed of a non-magnetic steel plate.

4. The rotating electric machine according to claim 1, further comprising a flux barrier provided at an end portion of the magnet insertion hole on a side of an inner periphery,
wherein an end portion of the magnet is in contact with the end portion of the magnet insertion hole.

5. The rotating electric machine according to claim 4, wherein a ratio (L2/L1) of a length (L1) along the magnet to a length (L2) of the flux barrier in contact with the magnet, and a ratio (W1/W3) of a width (W1) of the inner peripheral side rib to a width (W3) of the flux barrier are set to (L2/L1)≥(W1/W3).
